(19) United States
(12) Patent Application Publication
(10) Pub. No.: US 2025/0374135 A1
(43) Pub. Date: Dec. 4, 2025

(54) 5G CORE NETWORK SUPPORT FOR NON-TERRESTRIAL NETWORK CELLS

(71) Applicant: Microsoft Technology Licensing, LLC, Redmond, WA (US)

(72) Inventor: Tapas Kumar SARKAR, Telangana (IN)

(73) Assignee: Microsoft Technology Licensing, LLC, Redmond, WA (US)

(21) Appl. No.: 18/788,798

(22) Filed: Jul. 30, 2024

(30) Foreign Application Priority Data
May 31, 2024 (IN) 202411042352

(51) Int. Cl. H04W 36/00; H04W 28/18; H04W 64/00

(52) U.S. Cl. CPC H04W 36/008355; H04W 28/18; H04W 64/003

(57) ABSTRACT

A core network (CN) of a wireless network such as a 5G (5^{th} generation) network is adapted to provide support for non-terrestrial network (NTN) types to optimize signaling for effective resource and mobility management. The CN uses signaling with a next generation radio access network (NG-RAN) to determine when user equipment (UE) and network capabilities are mismatched with regard to supported satellite types (including geostationary satellite orbit (GSO) and non-geostationary satellite orbit (NGSO) types) to ensure that unnecessary paging is not implemented. The CN is further arranged to utilize an expanded tracking area identity (TAI) list that enables a unique tracking area code (TAC) to be defined and utilized for specific NTN cells. The CN is further arranged to utilize a target identifier (ID) used in handovers involving an NTN cell.

### PRIORITY CLAIM

This application claims priority under 35 U.S.C. § 119 to Indian Patent Application number 202411042352 filed in India on May 31, 2024 and titled “5G Core Network Support for Non-Terrestrial Network Cells,” the disclosure of which is incorporated by reference in its entirety herein.

### BACKGROUND

Satellite constellations will play a crucial role in providing ubiquitous connectivity as an integral part of 5th Generation (5G) and future generations of wireless networks. Satellites are expected to be utilized to support a variety of services such as mobile broadband and fixed Internet connectivity for ground users in unserved and underserved areas as well as wireless connectivity for Internet-of-Things (IoT). Satellites can also support communication services for airplanes and unmanned aerial vehicles (UAVs), facilitate tracking of ships and cargos, and provide backhaul for ground base stations in wireless networks.

### SUMMARY

Disclosed are a method, computer-readable storage device, and computing device configured for providing support by a core network portion of a wireless network (e.g., 4G and/or 5G network) for non-terrestrial networks (NTNs) using geostationary satellite orbit (GSO) and non-geostationary satellite orbit (NGSO) satellites. The core network is configured using a software-defined networking (SDN) architecture that supports an access and mobility management function (AMF) component that communicates over a control plane interface with a next generation radio access network (NG-RAN) to track NTN connectivity by user equipment (UE) to the wireless network. Such tracking enables the core network to know the type of NTN cell (GSO or NGSO) providing connectivity to the UE to enable the core network to efficiently manage network resources while ensuring effective mobility management that meets applicable quality of service (QOS) and other requirements.

In an illustrative embodiment, the AMF and NG-RAN perform signaling to determine instances of the UE and network satellite capabilities being mismatched. For example, the UE may support GSO while the network does not (and vice versa) or the UE may support NGSO while the network does not (and vice versa). In these instances, the core network will apply a paging policy to minimize unnecessary signaling to thereby reduce overhead and free up network resources. The paging policy includes enabling emergency paging only, disabling paging completely for the UE, and setting the NG-RAN priority to a minimum value.

In another illustrative embodiment, information elements (IEs) defined by ETSI (European Telecommunications Standards Institute) and 3GPP (3rd Generation Partnership Project) Release 17 for 5G networks and utilized to carry information in network signaling are modified to provide more specificity for NTN. In particular, the tracking area identity (TAI) list is expanded to include a list of TAIs belonging to an NTN cell to enable identification of a specific tracking area for UE as satellite coverage changes, for example, when a UE moves from a GSO to an NGSO coverage area. The expanded TAI list enables a unique tracking area code (TAC) to be defined and utilized for specific NTN cells. Use of the expanded TAI list resolves issues that result from satellite coverage footprints being large relative to terrestrial cells and overlapping NGSO and GSO coverage areas which can result in less-than-optimal UE tracking and excessive signaling overhead for mobility management.

In another illustrative embodiment, a new IE is created for a target identifier (ID) used in handovers involving an NTN cell. For example, when a UE moves from a GSO to an NGSO coverage area, the source NG-RAN sends a handover required message to the AMF that includes the new target ID IE which identifies the target of the handover. The target ID provides a globally unique ID for the NG-RAN node for the NGSO cell and also specifies a TAI to identify an associated tracking area.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows illustrative satellites orbiting the earth at different distances that are utilized to provide services to support wireless networks such as 4th and 5th generation (4G and 5G) networks;

FIG. 2 shows illustrative overlapping coverage areas of a non-geostationary satellite orbit (NGSO) satellite and a geostationary satellite orbit (GSO) satellite;

FIGS. 3, 4, and 5 show various illustrative architectures for 5G wireless networks using non-terrestrial network (NTN) access;

FIG. 6 shows an illustrative access and mobility management function (AMF) component and paging policy and control component supported in a core network (CN) of a wireless network;

FIG. 7 shows illustrative messaging between a next generation radio access network (NG-RAN) and an AMF to establish a connection per an NG application protocol (NGAP) described in ETSI (European Telecommunications Standards Institute) TS 138 413 v17;

FIG. 8 shows an illustrative information element (IE) that provides radio access technology (RAT) information for a tracking area code (TAC);

FIG. 9 shows illustrative messaging between an AMF and an NG-RAN pertaining to paging;

FIG. 10 shows an illustrative overview of a typical user equipment (UE) paging scenario;

FIG. 11 shows illustrative messaging between an AMF and an NG-RAN pertaining to UE radio capability;

FIG. 12 shows an illustrative IE providing information for UE-NR-capability in accordance with ETSI TS 138 331 v17;

FIG. 13 shows illustrative messaging between an AMF and an NG-RAN pertaining to RAN paging priority;

FIG. 14 shows an illustrative IE providing information for RAN paging priority;

FIG. 15 shows illustrative alternative paging scenarios implemented in accordance with paging policy of a CN operator;

FIG. 16 shows illustrative use cases in which a UE switches from services provided by respective GSO and NGSO satellites;

FIG. 17 shows an illustrative IE providing information for a tracking area identity (TAI) list as provided by ETSI TS 124 501 v17;

FIGS. 18, 19, and 20 show different illustrative TAI lists as provided by ETSI TS 124 501 v17;

FIG. 21 shows a modification in accordance with the present principles to Table 9.11.3.9.1: “Tracking area identity list information element” as provided by ETSI TS 124 501 v17;

FIG. 22 shows illustrative messaging between an AMF and an NG-RAN pertaining to a TAI list;

FIG. 23 shows illustrative messaging between an AMF and a source NG-RAN pertaining to re-registration of a UE when switching service from a GSO satellite to service from an NGSO satellite;

FIGS. 24 and 25 show illustrative messaging between an AMF and a target NG-RAN pertaining to handover of a UE when switching service from a GSO satellite to service from an NGSO satellite;

FIG. 26 shows a new IE in accordance with the present principles for identifying an NTN target for a handover;

FIGS. 27, 28, and 29 show illustrative methods that may be implemented in a CN of a wireless network in accordance with the present principles;

FIG. 30 is a simplified block diagram of an illustrative computing device that may be used, at least in part, to implement aspects of the present principles; and

FIG. 31 shows details of an illustrative 4G/5G CN implemented using a software-defined networking (SDN) architecture.

Like reference numerals indicate like elements in the drawings. Elements are not drawn to scale.

### DETAILED DESCRIPTION

Non-terrestrial networks (NTN) refer to communication networks that do not rely solely on conventional terrestrial infrastructure, such as land-based cellular antennas or fiber optic cables. Instead, NTN is based on various non-terrestrial technologies and platforms to provide connectivity for user equipment (UE) to wireless networks such as 4G LTE (4th generation, long term evolution) and 5G (5th generation) networks.

A common form for NTN includes satellites, deployed individually, or more commonly, in constellations, that can support broadband internet access, telecommunication services, and data connectivity to remote and underserved areas. Satellites can also provide connectivity and coverage for use cases pertaining to disaster resilience, global connectivity, IoT (Internet-of-Things) enablement, broadcasting/multicasting, global roaming, network capacity offload, and other scenarios.

Standardization of NTN is ongoing within 3GPP (3rd Generation Partnership Project), with key developments in Releases 17, 18, and the upcoming Release 19. This includes optimizations for terminal performance, uplink capacity, broadcast service notification, and support for 5G system functions on board NTN vehicles.

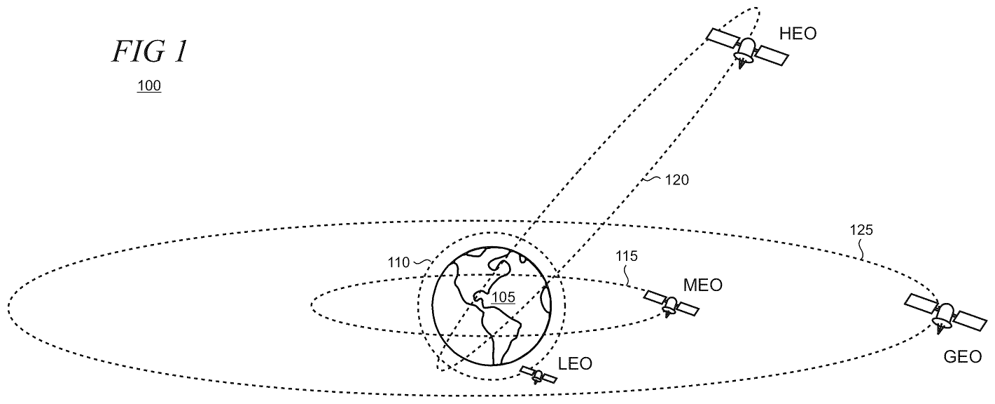

Turning now to the drawings, FIG. 1 shows an illustrative arrangement 100 of satellites orbiting the Earth 105 at different distances that are utilized to provide services to support various wireless networks. The satellite orbits include a low-earth orbit (LEO) 110 with an altitude range of 300-1,500 km (all altitudes are illustrative and not limiting), medium earth orbit (MEO) 115 with an altitude range of 7,000 to 25,000 km, and highly elliptical orbit (HEO) 120 having an oblong orbit with one end closer to the Earth and the other more distant, resulting in high eccentricity. The LEO, MEO, and HEO orbits are examples of a non-geostationary satellite orbit (NGSO) that does not maintain a fixed position for the satellite relative to the Earth's surface. Instead, the NGSO satellites are constantly moving across the sky from a ground observer's perspective.

A satellite having geostationary earth orbit (GEO) 125 maintains a fixed position above the Earth's equator at an altitude around 36,000 km and appears stationary from a ground observer's perspective. A geostationary satellite orbit (GSO) satellite can provide continuous coverage over a large, fixed area and is always visible to ground antennas. NGSO satellites may experience periods of signal block or loss of line-of-sight, but can provide global coverage when multiple satellites are deployed in constellations. NGSO satellites generally offer lower latency and higher broadband speeds compared to GEO satellites due to their closer proximity to Earth. The shorter distances and faster orbits of NGSO satellites can also enable more efficient use of radio frequency spectrum.

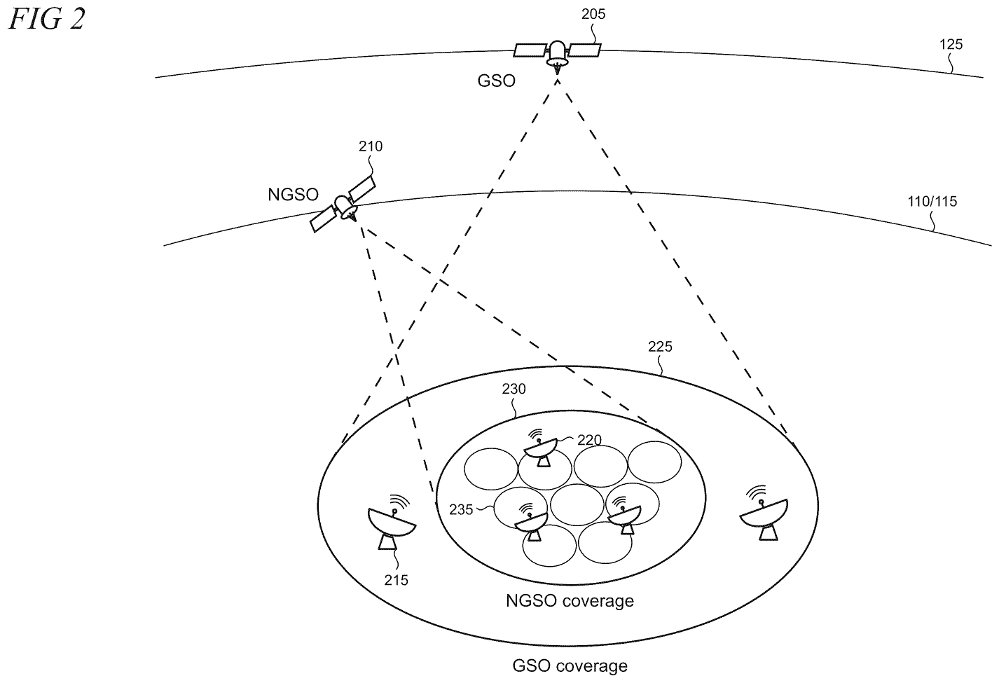

FIG. 2 shows illustrative overlapping coverage areas of a GSO satellite 205 in a GEO orbit 125 and an NGSO satellite 210 in an LEO 110 or MEO 115 orbit. The GSO and NGSO satellites interoperate with respective suitable NTN gateways 215 and 220 that function as ground stations. The GSO satellite provides a large coverage area 225 compared to coverage area 230 of the NGSO satellite. A single GSO satellite can provide coverage for about a third of the Earth's surface and a constellation of three GSO satellites can provide essentially full coverage (minus the polar regions). Thus, the GSO satellite can provide coverage for entire countries or continents in some cases.

In this illustrative example, the NGSO satellite 210 is arranged to use multiple beams. Thus, the coverage area 230 for the NGSO satellite is made up from the footprints (representatively indicated by reference numeral 235) of the multiple beams. A typical beam footprint size is 100-1000 km for an NGSO satellite in LEO or MEO orbits. By comparison, the single beam shown for the GSO satellite has a footprint size of around 200-3500 km. The beam footprint sizes of the respective satellites are larger than their terrestrial cell counterparts and can often overlap.

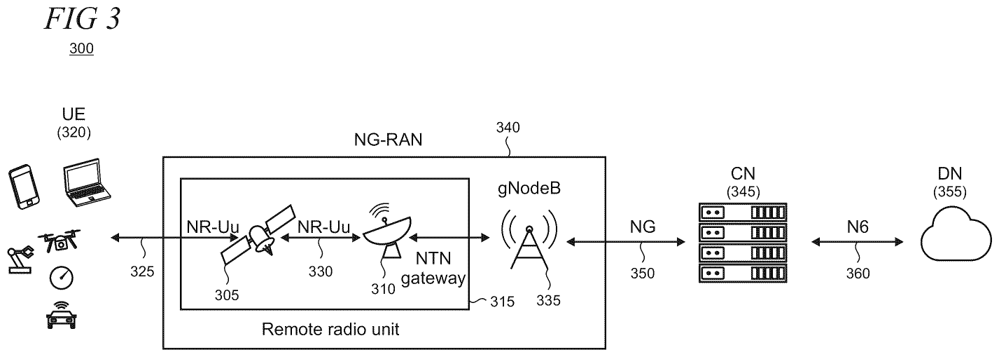

FIGS. 3, 4, and 5 show various illustrative architectures for 5G wireless networks using non-terrestrial network (NTN) access as discussed in 3GPP Release 17. It may be appreciated that the inventive principles and associated discussion of software-defined networking (SDN)-based components presented herein may also be applied to the core and radio access networks in 4G LTE networks with suitable adaptations.

FIG. 3 shows an illustrative SDN-based 5G network 300 using a transparent payload satellite access architecture. With transparent communication payload, radio frequency (RF) filtering, frequency conversion, and amplifications are performed only at the satellite 305. Thus, the waveform signal repeated by the payload is unchanged.

An NTN gateway 310 forms a remote radio unit (RRU) 315 with the satellite 305. The NTN gateway serves as a bridge between the satellite 305 and UE 320 by extending the same NR-Uu interface to both the service link 325, from the UE to the satellite, and the feeder link 330 from the satellite to the NTN gateway. One or more transparent satellites may be connected to the same gNodeB 335 on the ground. The satellite repeats the NR-Uu radio interface signals from the feeder link to the service link and vice versa. This approach allows for a continuous flow of data between the terrestrial network and the UE despite the involvement of satellite links.

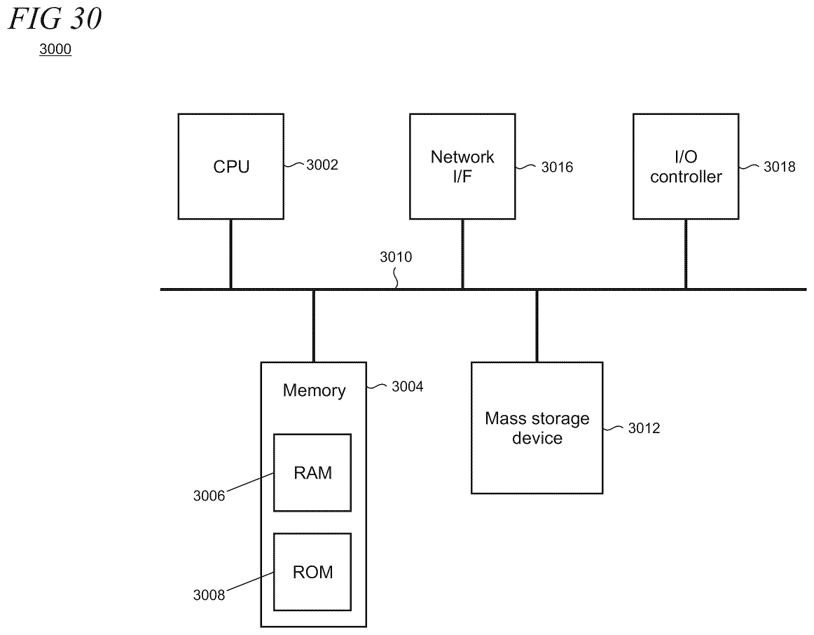

The combination of RRU 315 and gNodeB 335 forms an NG-RAN 340 in this illustrative example. The NG-RAN is coupled to a core network (CN) 345 via an NG interface 350. The CN provides for central management and control of the 5G network 300 and is described in more detail in the description accompanying FIG. 30 below. The CN is coupled to an external data network (DN) 355 such as the Internet, enterprise networks, cloud-based services, and the like over an N6 interface 360, to support user access to various external services, content, and applications.

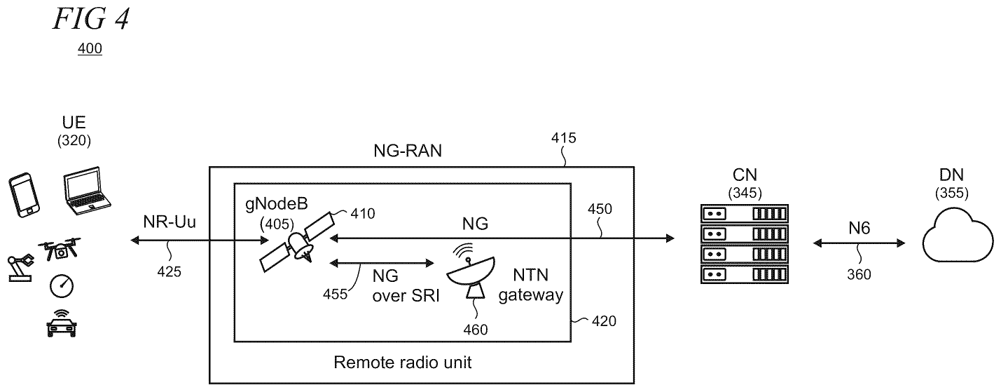

FIG. 4 shows an illustrative SDN-based 5G network 400 using a regenerative payload (i.e., non-transparent) satellite access architecture. With regenerative communication payload, RF filtering, frequency conversion and amplification along with demodulation/decoding, switching, and/or routing, coding/modulation is performed at the satellite. This is effectively equivalent to having all or some part of gNodeB 405 functions on board the satellite 410 enabling enhanced signal processing and relay capabilities. Accordingly, the NG-RAN 415 comprises just the RRU 420 as the ground-based gNodeB is replaced by the satellite-based gNodeB.

An NR-Uu interface is utilized on the service link 425 between the UE 320 and the satellite 410. An NG interface is utilized on the link 450 between the RRU 420 and the CN 345. The NG interface is implemented over a satellite radio interface (SRI) in the air path 455 between the satellite and the NTN gateway 460.

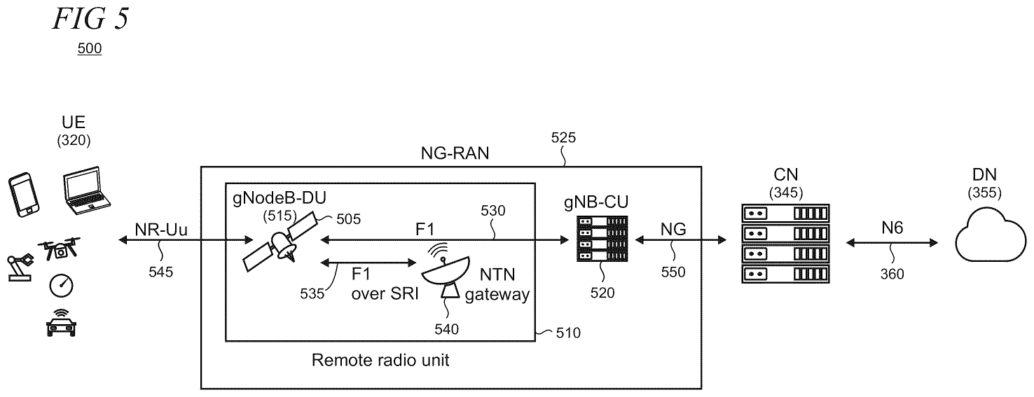

FIG. 5 shows an illustrative SDN-based 5G network 500 using a regenerative payload satellite access architecture in which the satellite 505 in the RRU 510 is further provided with functionality of a distributed unit (DU), as indicated by reference numeral 515. Under 3GPP, a gNodeB base station is logically divided into a centralized unit (CU) and DU. The CU provides support for the higher layers of the protocol stack, such as service data adaptation protocol (SDAP), packet data convergence protocol (PDCP), and radio resource control (RRC). The CU manages less time-sensitive control-plane functions like session management, radio resource control, and mobility control. The DU provides support for the lower layers of the protocol stack, such as radio link control (RLC), medium access control (MAC), and physical layer (PHY). The DU handles time-sensitive processing like error correction, scheduling, modulation, and demodulation.

In this architecture, the CU 520 is located on the ground as part of the NG-RAN 525. The satellite 505 is connected to the CU via an F1 interface on link 530. The F1 interface is implemented over SRI in the air path 535 between the satellite and the NTN gateway 540. NR-Uu is the radio interface utilized on the link 545 between the UE 320 and the DU 515 onboard the satellite. An NG interface is utilized on the link 550 between the CU and the CN 345. In some applications, the DUs in different satellites (e.g., satellites in a constellation) may be connected to the same CU on the ground.

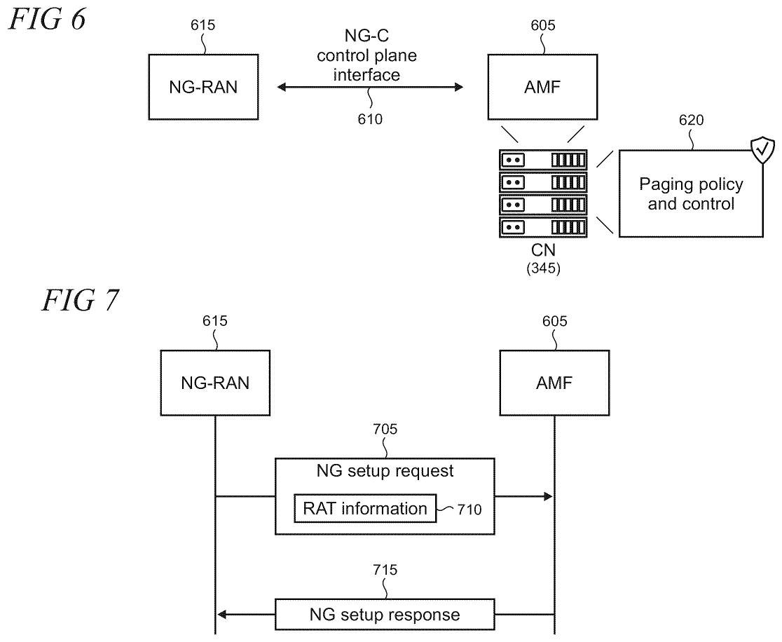

FIG. 6 shows an illustrative access and mobility management function (AMF) component 605 instantiated in the CN 345. The AMF communicates via standard signaling protocols over an NG-C interface 610 with an NG-RAN 615 that is arranged for NTN support. The CN is also configured to support a paging policy and control component 620 that is described in more detail below.

FIG. 7 shows illustrative messaging between NG-RAN 615 and AMF 605 to establish a connection per an NG application protocol (NGAP) described in 3GPP (3rd Generation Partnership Project) TS 38.413 for Release 17. The NG-RAN sends an NG setup request 705 that includes a RAT information element (IE) 710. The NG setup request is a part of the NG setup procedure used to exchange application-level data needed for the NG-RAN node and AMF to correctly interoperate on the NG-C interface. It is the first NGAP procedure triggered after the transport network layer (TNL) association has become operational to establish a logical connection between the NG-RAN and AMF. An NG setup response 715 sent from the AMF to the NG-RAN typically allows the AMF to provide configuration data for the NG-RAN to enable proper interoperations.

FIG. 8 shows the RAT information IE, as indicated by reference numeral 800, for a tracking area code (TAC) as described in section 9.3.1.125 of ETSI (European Telecommunications Standards Institute) TS 23.501 v17 pertaining to 3GPP Release 17. It is noted that ETSI publishes 3GPP standards as ETSI deliverables after being developed and approved by 3GPP. ETSI is one of the seven telecommunications standards development organizations that make up 3GPP. As shown, the RAT information IE includes a field in which a specific satellite RAT is being used when a UE registers with a 5G network using an NG-RAN providing NTN access. This information enables the AMF 605 and CN 345 to properly handle the UE and apply appropriate policies and procedures for the given satellite RAT type.

3GPP Release 17 defines several categories of RAT types for satellite access in 5G networks including NR (LEO) for NR (new radio) RAT type for satellite access using LEO satellites, NR (MEO) for NR RAT type for satellite access using MEO satellites, NR (GEO) for NR RAT type for satellite access using GEO satellites, and NR (OTHERSAT) which provides a catch-all RAT type for other types of satellite access not covered by the other satellite categories.

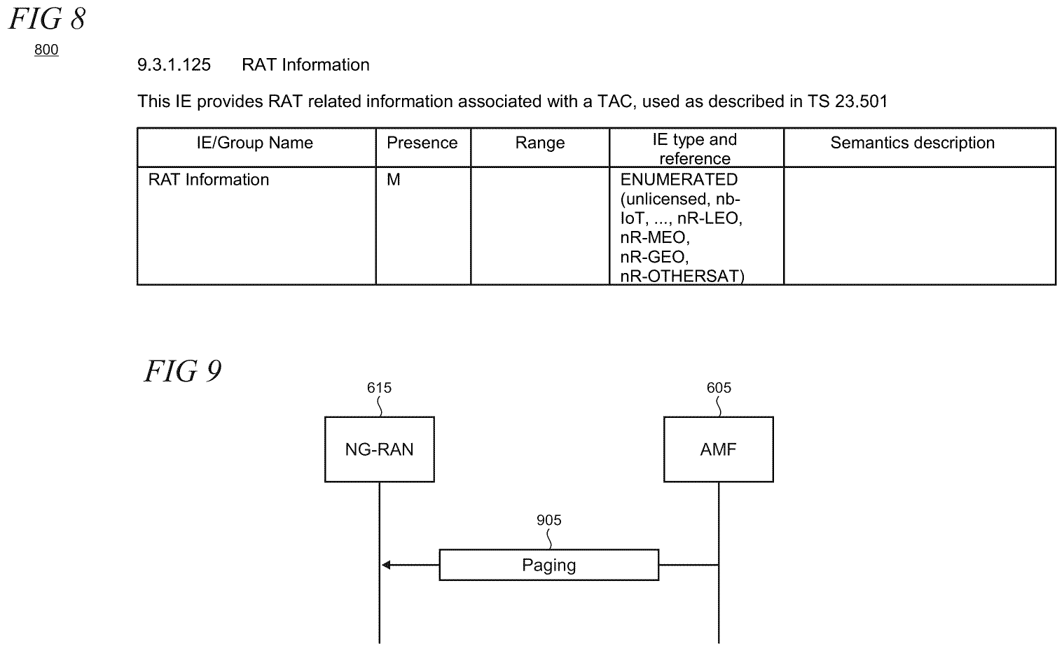

In accordance with the present principles, the knowledge of RAT type for satellite access can be utilized by the CN to optimize internal operations including non-access stratum (NAS) signaling between the CN and UE. For example, FIG. 9 shows illustrative signaling 905 between AMF 605 and NG-RAN 615 pertaining to a paging procedure. Paging in 5G is a mechanism used to notify idle UE about incoming data, call requests, or network updates.

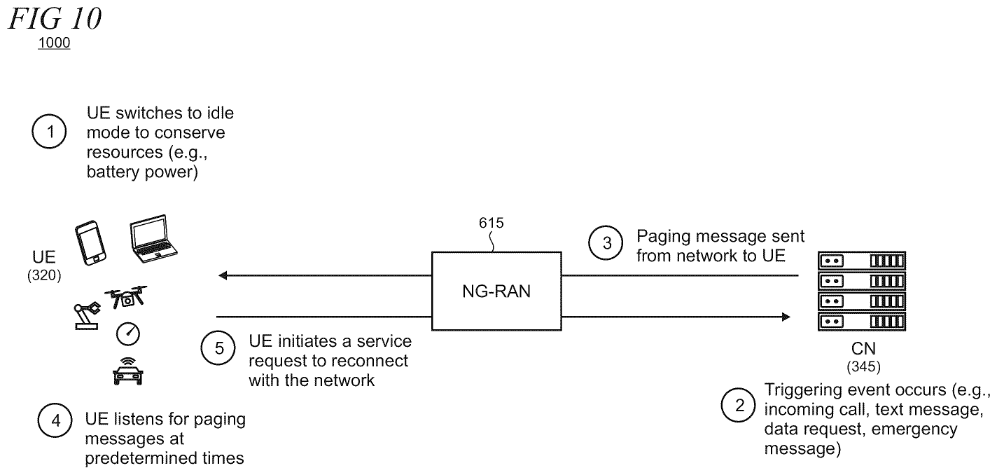

FIG. 10 shows an illustrative overview of a typical UE paging scenario 1000. Paging involves a network trigger, a paging message, and a UE response. The CN 345 can track and manage the paging activities using suitable logs to facilitate efficient signaling and communication management. At stage 1, the UE 320 switches to idle mode, for example to conserve resources such as battery power. At stage 2, a triggering event occurs in the network. Triggering events may include, for example, an incoming call to the UE, a text message, a data request, an emergency message or notification, and the like.

At stage 3, a paging message is sent from the AMF in the CN 345 to the NG-RAN 615 using the paging procedure with NAS signaling. The UE 320 listens for paging messages at predetermined times (termed “paging occasions”) at stage 4. The UE can enter a discontinuous reception (DRX) mode, where it only wakes up during the paging occasions to check for incoming data or calls. Paging occasions enable the UE to only monitor the paging channel during specific time intervals, rather than continuously, to reduce power consumption. Responsively to the received paging message, the UE initiates a service request to reconnect with the 5G network at stage 5.

The paging procedure in 5G networks can involve significant signaling overhead compared to previous cellular generations. The paging procedure in 5G is more complex due to the use of directional beams, which requires the paging message to be transmitted over multiple time slots to cover the entire cell area. This increases the system capacity requirement for paging compared to, for example, the omnidirectional paging in 4G LTE. Thus, the signaling load from paging can be high, especially if the tracking area consists of a large number of cells. This results because a paging message needs to be transmitted to all the cells in the tracking area of the UE, leading to a significant paging load over the air interface and the NG-C interface between the AMF and NG-RAN. In addition, 5G systems use a registration area which groups multiple tracking areas for a particular UE. This can reduce the signaling overhead from mobility updates, as the UE only needs to perform a mobility update when it leaves its registration area. However, this comes at the cost of increased paging overhead, as the paging message needs to be transmitted over all the cells in the registration area.

Optimized management of paging signaling overhead is desirable in the CN 345 to enable CN resources to be efficiently utilized. The inventor has recognized that unnecessary paging signaling can be reduced to thereby free up CN resources in cases in which there is a mismatch between UE and 5G network capabilities with regard to NTN. For example, in a first case, the UE may support GSO while the network does not (and vice versa) or in a second case, the UE may support NGSO while the network does not (and vice versa).

For both case 1 and 2, there may be two UE scenarios to consider. In scenario 1, the UE 320 may mark a particular NTN cell as barred. Marking an NTN cell as barred is a way for the CN to temporarily restrict access to that cell to manage network resources and prevent overload without permanently blocking users from that cell. In this scenario, paging signaling optimization is not needed because the UE will not be able to attempt to register with the mismatched NTN cell. However, if the UE does not mark the cell as barred, the UE will try to register the cell with the CN. In this scenario, if the CN enables registration, then unnecessary and ineffective signaling will be attempted which will degrade the user experience at the UE because of the mismatch between UE and network capabilities and other service level parameters.

As discussed below, the AMF and NG-RAN may perform signaling to determine instances when the UE and network satellite capabilities are mismatched and then apply an appropriate paging policy to minimize the paging signaling.

FIG. 11 shows illustrative messaging between the AMF 605 and NG-RAN 615 pertaining to UE radio capability. The NG-RAN sends an initial UE message 1105 when the UE is attempting to access the 5G network as part of the overall 5G registration and connection setup flow. After receiving the initial UE message, the CN can proceed with the authentication, security, and registration procedures to fully establish the UE's connection and context in the 5G network.

The AMF 605 sends a downlink NAS transport message 1110 to the NG-RAN 615. The message includes a UE radio capability info request 1115 to inquire about the UE's radio capabilities. The NG-RAN responds with a UE radio capability info indication 1120 to report its supported radio capabilities to the CN.

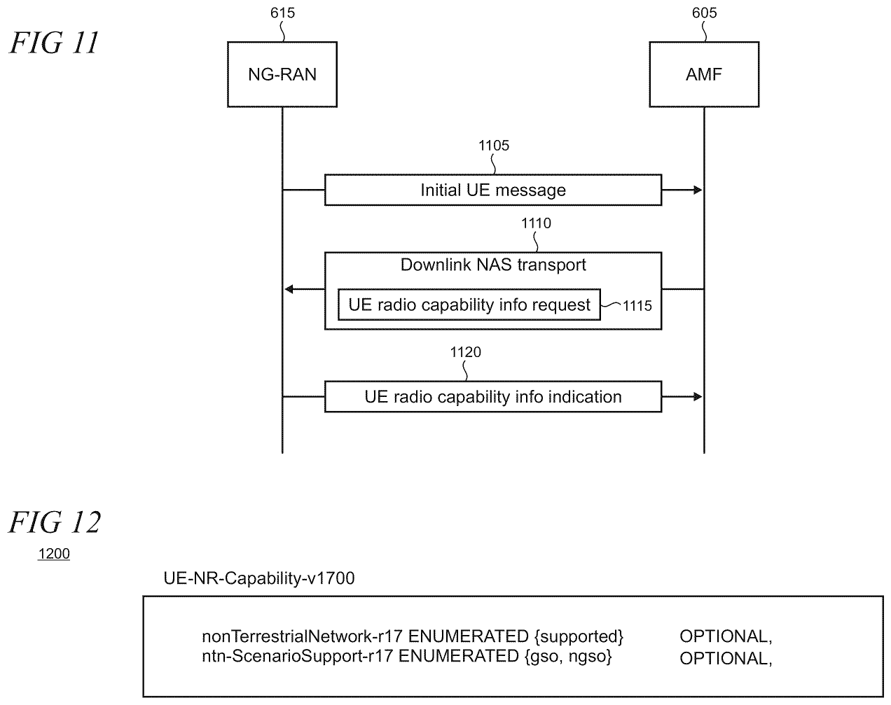

FIG. 12 shows an illustrative IE 1200 providing information for UE-NR-capability in accordance with ETSI TS 138 331 v17. The IE provides for the UE to advertise whether the UE is GSO-capable or NGSO-capable. As noted above in the discussion accompanying FIGS. 7 and 8, the CN determines the RAT type for the UE access from the RAT information IE. If the CN determines from the signaling that the UE and network are mismatched, for example, the UE is capable of GSO and the satellite is NGSO (or vice versa), then a suitable paging policy may be applied to optimize paging signaling. For example, the paging policy and control component 620 can store various policies and initiate policy application in the CN. Alternatively, paging policy and control functionality can be integrated with existing network functions and/or components in the CN.

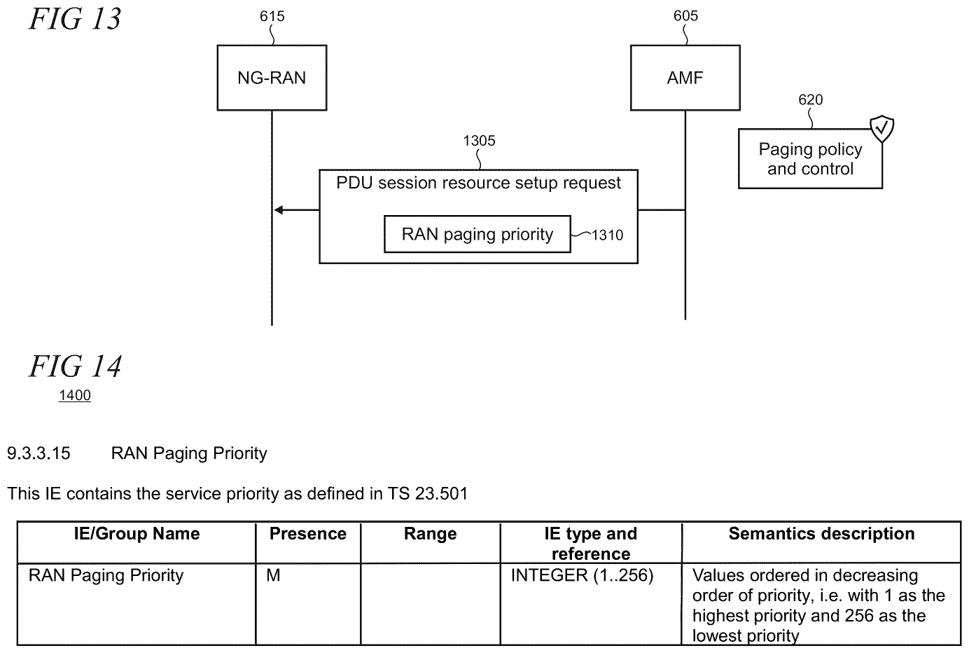

In an illustrative example, paging policy can include the setting of RAN paging priority. FIG. 13 shows illustrative messaging between the AMF 605 and NG-RAN and AMF in which a PDU (protocol data unit) resource setup request 1305 includes a RAN paging priority IE 1310. The RAN paging priority IE 1400 in accordance with ETSI TS 138 413 v17 is shown in FIG. 14. RAN paging priority may be set to a low value (e.g., 256) to thereby minimize paging signaling.

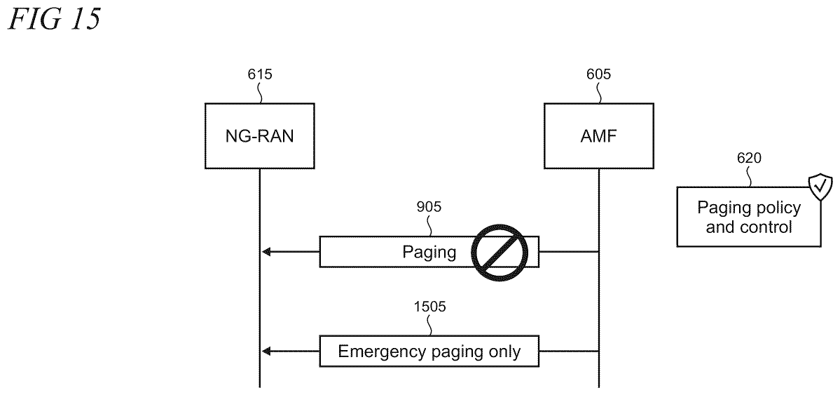

FIG. 15 shows illustrative alternative paging scenarios implemented in accordance with paging policies from the paging policy and control component 620 to minimize paging signaling. The AMF 605 may disable all paging messages 905 to the NG-RAN 615 pertaining to paging or implement paging messages 1505 for emergency paging scenarios only. Emergency pages typically include alert broadcasts and other emergency communications that ensure users receive important information even when their UE are not actively in use.

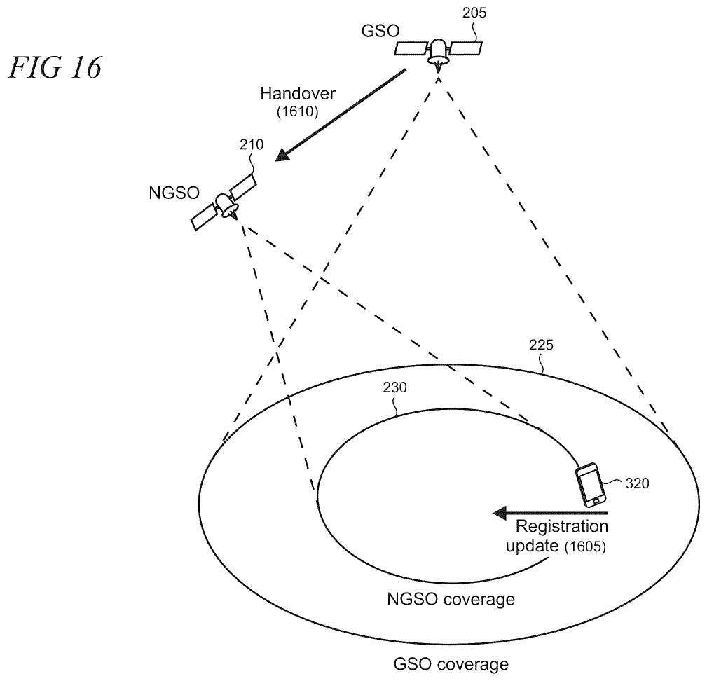

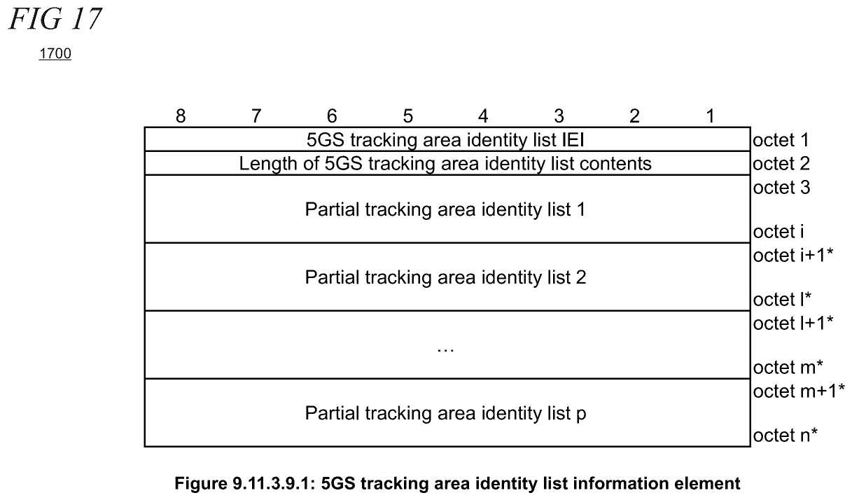

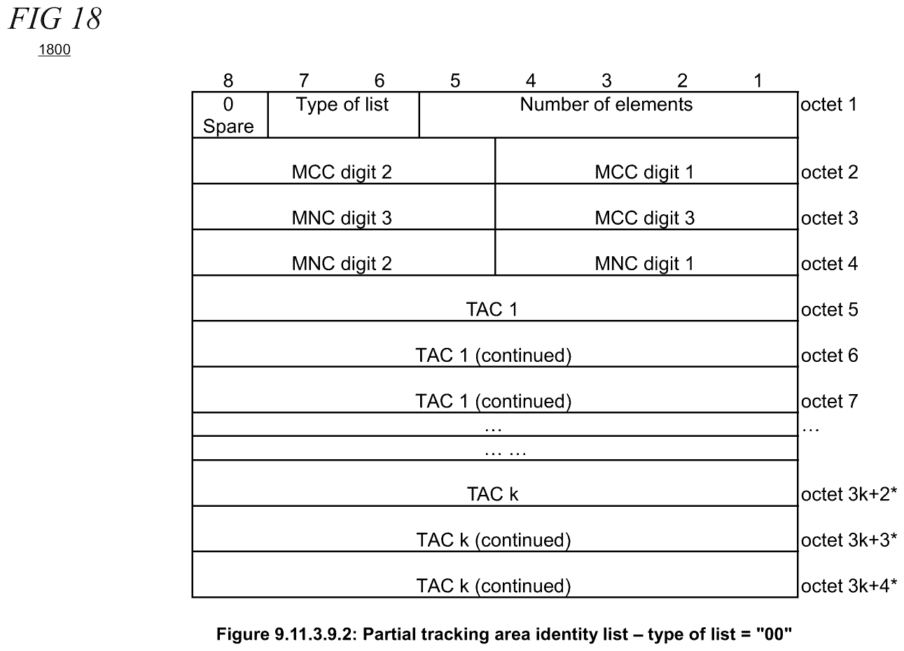

FIG. 16 shows illustrative use cases in which a UE 320 switches from access services provided by a GSO satellite 205 to access services supported by an NGSO satellite 210. The use cases involve a registration update 1605 and handover 1610. In the registration update use case, the UE enters the NGSO coverage area 230 and switches from the GSO coverage area 225 because access services from the NGSO satellite are better suited for the UE to provide or maintain certain QoS levels for given user experiences and/or applications. For example, the UE may switch from GSO to NGSO access service to obtain lower latency for services and applications.

As shown in FIG. 16, the GSO and NGSO coverage areas overlap, which the inventor has recognized can cause issues in identifying the tracking area (also referred to as “registration area”) for UE due to overlapping TACs. In addition, the NTN cells typically have significantly larger footprints than conventional terrestrial cells and the number of TACs supported in the 5G network are limited. These characteristics of NTN cells and limitations of current standards can result in less-than-optimal CN resource allocation and utilization because substantial NAS and AS signaling overhead can be expected to be borne when dealing with UE mobility management with NTN cells. Accordingly, the inventor has recognized the need for a mechanism to provide for tracking areas for NTN cells (both fixed and moving) corresponding to a unique and fixed geographic area that is comparable to the size of terrestrial network cell. Such a mechanism can ensure that the CN is updated with suitable tracking areas that correspond to changes in RAT types for NTN cells.

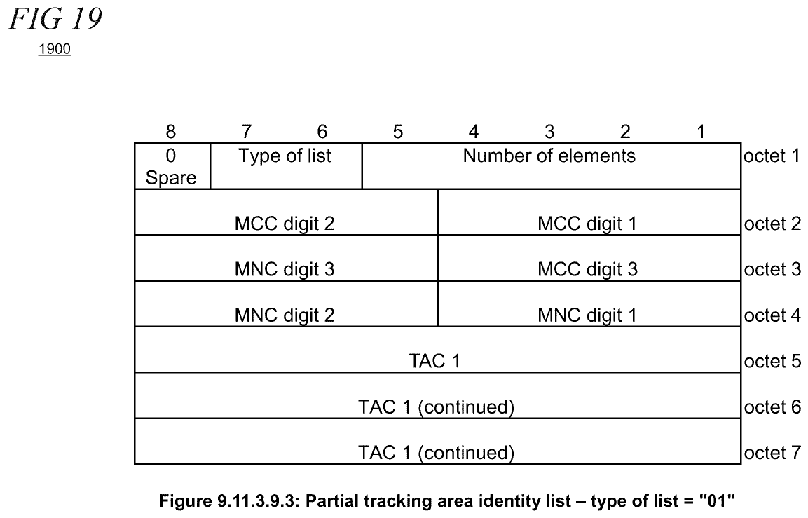

A solution for issues raised by current tracking areas in NTN cells is the expansion of the types of TAI lists specified in ETSI TS 125 501 v17 to specifically include a list of TAIs belonging to an NTN cell. Currently, the standard provides for three types of TAI lists. As shown in FIG. 17, a TAI list IE 1700 is used to transfer a list of TAIs from the CN to the UE as provided by Figure 9.11.3.9.1 in ETSI TS 124 501 v17. The TAI list is a type 4 IE with a minimum length of 9 octets and maximum length of 114 octets. With bit 5 being reserved and bit 8 being spare, the TAI list can include a maximum of 16 different TAIs. A TAI in 3GPP is constructed from the public land mobile network (PLMN) identity to which the tracking area belongs, and the tracking area code (TAC) of the tracking area.

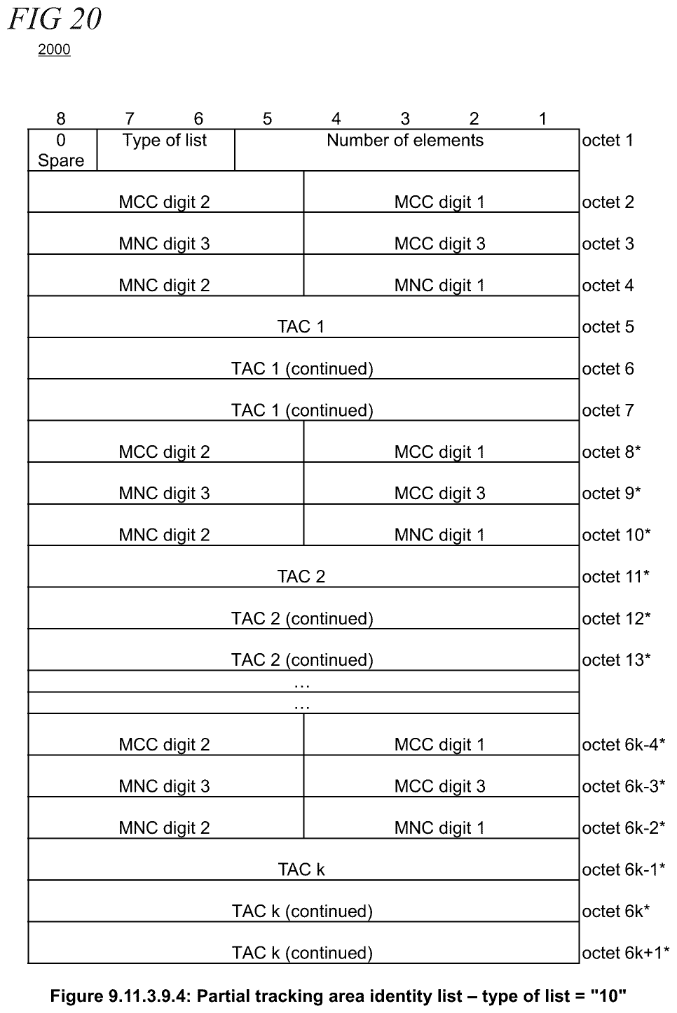

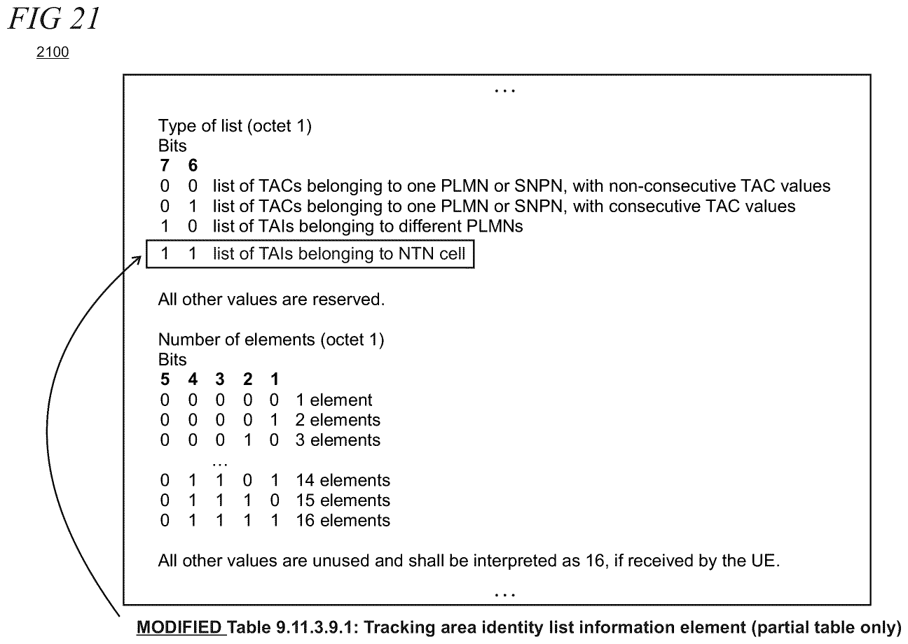

FIGS. 18, 19, and 20 show different TAI lists 1800, 1900, and 2000 as respectively provided by Figures 9.11.3.9.2, 9.11.3.9.3, and 9.11.3.9.4 in ETSI TS 124 501 v17. Table 9.11.3.9.1 of ETSI TS 124 501 v17, as indicated by reference numeral 2100 in FIG. 21, uses bits 6 and 7 in octet 1 to specify the type of TAI list. Accordingly, the TAI list 1800 in FIG. 18 has the type of list=“00”. The TAI list 1900 in FIG. 19 has the type of list=“01”. The TAI list 2000 in FIG. 20 has the type of list=“10”.

FIG. 21 also shows a modification in accordance with the present principles to Table 9.11.3.9.1. Here, a new type of TAI list=“11” is proposed to create a new TAI list that provides a list of TAIs belonging to an NTN cell, as shown. If bits 5 (reserved) and 8 (spare) are utilized, then the TAIs in the new “11” list can be extended to 64 different TAIs. By extending the TAI list to specifically cover GSO and NGSO, a globally unique TAC may be defined for NTN cells that are more comparable to tracking areas for conventional terrestrial cells.

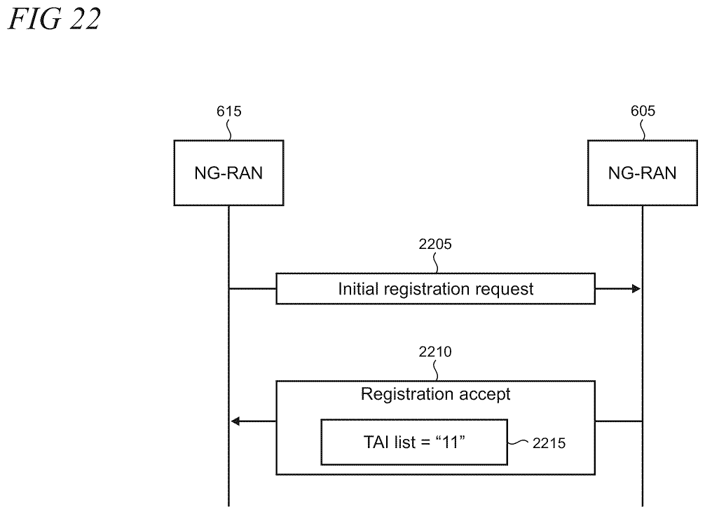

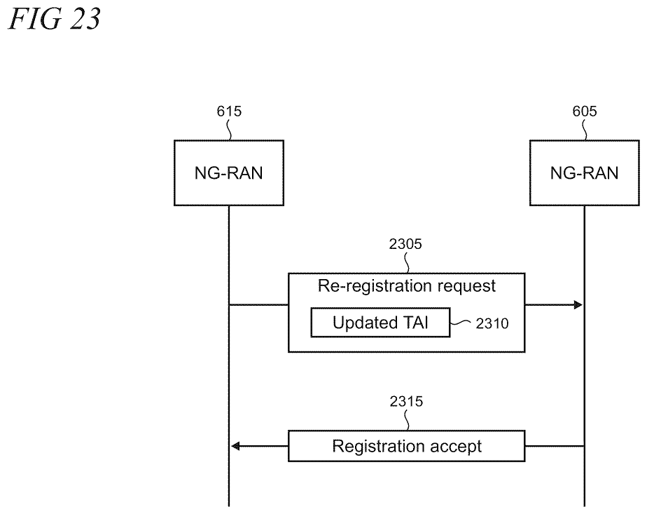

The extended TAI list (i.e., type of list=“11”) can be provided to the NG-RAN 615 from the AMF 605 using conventional signaling as illustratively shown in FIG. 22. Responsively to an initial registration request 2205 from the NG-RAN, the AMF sends a registration accept message 2210 that includes the extended TAI list 2215. When the UE re-registers with the CN for the NGSO cell, as shown in FIG. 23, the NG-RAN sends a re-registration request 2305 to the AMF with an updated TAI 2310 selected from the extended TAI list. The CN can provide for mobility management with optimized signaling levels using the updated TAI. The AMF responds to the re-registration request with a registration accept message 2315, as shown.

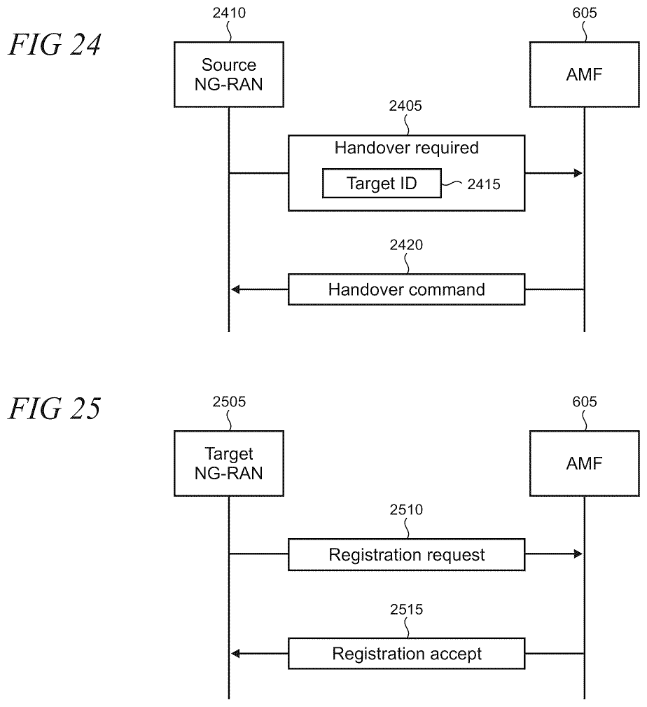

For the handover use case shown in FIG. 16 and described in the accompanying text, a handover required message 2405 is sent from a source NG-RAN 2410 to the AMF 605 as shown in FIG. 24. The handover required message is initiated to enable a UE to maintain a continuous connection with the 5G network as it moves from one NTN cell to another. A handover may be initiated by the network, for example, based on factors such as signal quality, UE mobility, QoS factors, and network load balancing. The AMF prepares for the handover and responds with a handover command 2420 to the source NG-RAN to proceed with handover execution. As shown in FIG. 25, the target NG-RAN 2505 sends a registration request 2510 to the AMF to which the AMF responds with a registration accept message 2515 to complete the handover.

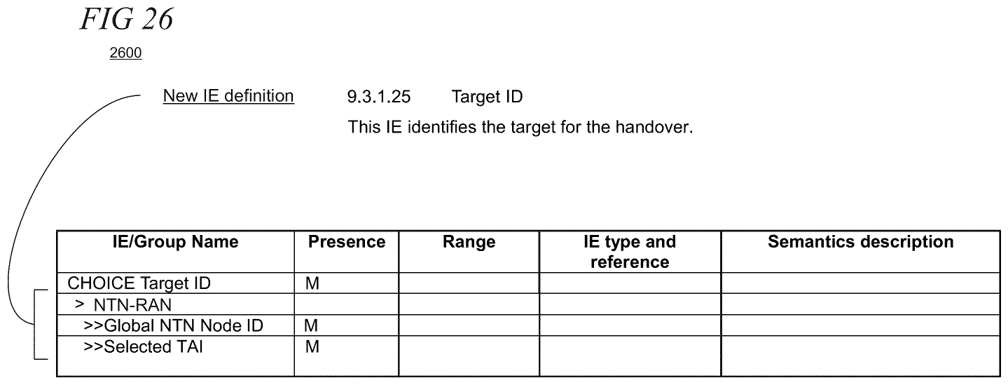

Returning to FIG. 24, the handover required message 2405 includes a target ID 2415 that provides a global gNodeB ID and TAI for the target cell in accordance with ETSI TS 138 413 v17. However, the standard currently does not specifically provide a target ID for NTN cells. The inventor proposes that this be remedied by modifying the target ID IE to include NTN-specific entries. As shown in FIG. 26, a new IE in accordance with the present principles for identifying an NTN target for a handover is defined for inclusion in the IE specified by section 9.3.1.25. The new IE definition, indicated by reference numeral 2600, provides for a globally unique NTN node ID and a corresponding selected TAI. Utilization of the new IE definition for target ID enables the source NG-RAN to provide specific NTN parameters to the CN to indicate a handover between NTN cells and non-NTN cells as well. As with the UE registration update use case, the provisioning of specific NTN cell information enables the CN to optimize mobility management and associated signaling while ensuring the provided service meets all applicable requirements.

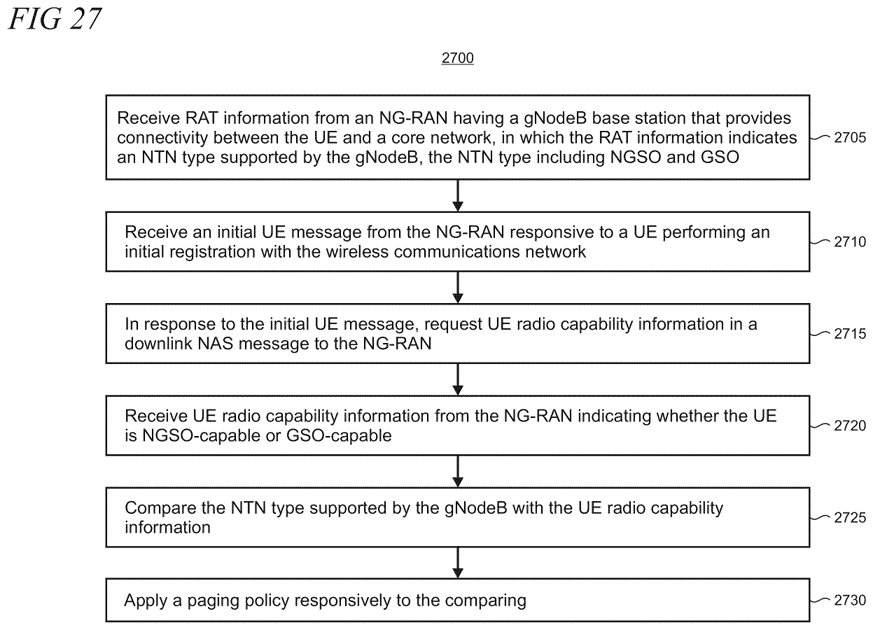

FIG. 27 is a flowchart of an illustrative method 2700 that is performable by a computing device in a CN of a wireless communications network. Unless specifically stated, methods or steps shown in the flowchart blocks and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 2705 includes receiving RAT information from an NG-RAN having a gNodeB base station that provides connectivity between the UE and a core network, in which the RAT information indicates an NTN type supported by the gNodeB, the NTN type including NGSO and GSO. Block 2710 includes receiving an initial UE message from the NG-RAN responsive to a UE performing an initial registration with the wireless communications network.

Block 2715 includes, in response to the initial UE message, requesting UE radio capability information in a downlink NAS (non-access stratum) message to the NG-RAN. Block 2720 includes receiving UE radio capability information from the NG-RAN indicating whether the UE is NGSO-capable or GSO-capable.

Block 2725 includes comparing the NTN type supported by the gNodeB with the UE radio capability information. Block 2730 includes applying a paging policy responsively to the comparing.

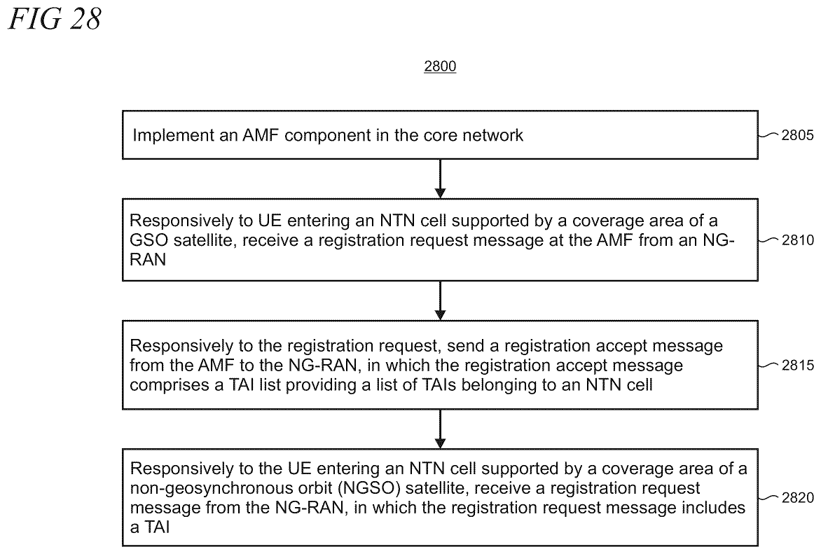

FIG. 28 is a flowchart of an illustrative method 2800 that is performable by a computing device in a CN. Block 2805 includes implementing an AMF component in the CN. Block 2810 includes, responsively to UE entering an NTN cell supported by a coverage area of a GSO satellite, receiving a registration request message at the AMF from an NG-RAN.

Block 2815 includes, responsively to the registration request, sending a registration accept message from the AMF to the NG-RAN, in which the registration accept message comprises a TAI list providing a list of TAIs belonging to an NTN cell. Block 2820 includes, responsively to the UE entering an NTN cell supported by a coverage area of a NGSO satellite, receiving a registration request message from the NG-RAN, in which the registration request message includes a TAI.

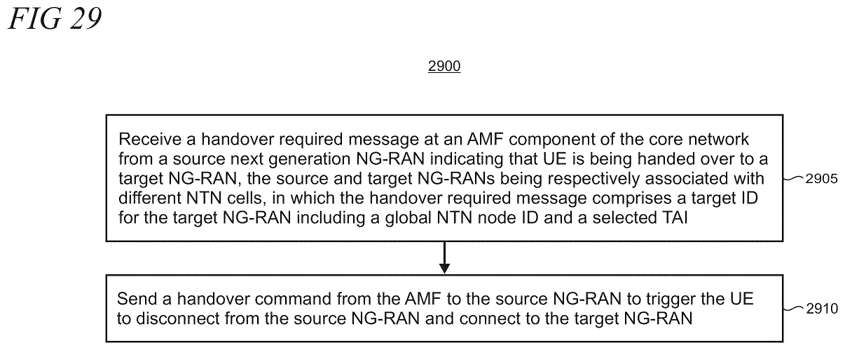

FIG. 29 is a flowchart of an illustrative method 2900 that is performable by a computing device in a CN. Block 2905 includes receiving a handover required message at an AMF component of the core network from a source next generation NG-RAN indicating that UE is being handed over to a target NG-RAN, the source and target NG-RANs being respectively associated with different NTN cells, in which the handover required message comprises a target ID for the target NG-RAN including a global NTN node ID and a selected TAI.

Block 2910 includes sending a handover command from the AMF to the source NG-RAN to trigger the UE to disconnect from the source NG-RAN and connect to the target NG-RAN.

FIG. 30 shows an illustrative architecture 3000 for a computing device, such as a server, capable of executing the various components described herein for the present principles. The architecture 3000 illustrated in FIG. 30 includes one or more processors 3002 (e.g., central processing unit, dedicated AI chip, graphics processing unit, etc.), a system memory 3004, including RAM (random access memory) 3006 and ROM (read only memory) 3008, and a system bus 3010 that operatively and functionally couples the components in the architecture 3000. A basic input/output system containing the basic routines that help to transfer information between elements within the architecture 3000, such as during startup, is typically stored in the ROM 3008. The architecture 3000 further includes a mass storage device 3012 for storing software code or other computer-executed code that is utilized to implement applications, a file system, and an operating system (OS). The mass storage device 3012 is connected to the processor 3002 through a mass storage controller (not shown) connected to the bus 3010. The mass storage device 3012 and its associated computer-readable storage media provide non-volatile storage for the architecture 3000. Although the description of computer-readable storage media contained herein refers to a mass storage device, such as a hard disk or CD-ROM drive, it may be appreciated by those skilled in the art that computer-readable storage media can be any available storage media that can be accessed by the architecture 3000.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray or other optical storage, magnetic cassettes, magnetic tape, magnetic disk storage or other magnetic storage devices, or any other medium which can be used to store the desired information and which can be accessed by the architecture 3000.

According to various embodiments, the architecture 3000 may operate in a networked environment using logical connections to remote computers through a network. The architecture 3000 may connect to the network through a network interface unit 3016 connected to the bus 3010. It may be appreciated that the network interface unit 3016 also may be utilized to connect to other types of networks and remote computer systems. The architecture 3000 also may include an input/output controller 3018 for receiving and processing input from a number of other devices, including a keyboard, mouse, touchpad, touchscreen, control devices such as buttons and switches or electronic stylus (not shown in FIG. 30). Similarly, the input/output controller 3018 may provide output to a display screen, user interface, a printer, or other type of output device (also not shown in FIG. 30).

It may be appreciated that the software components described herein may, when loaded into the processor 3002 and executed, transform the processor 3002 and the overall architecture 3000 from a general-purpose computing system into a special-purpose computing system customized to facilitate the functionality presented herein. The processor 3002 may be constructed from any number of transistors or other discrete circuit elements, which may individually or collectively assume any number of states. More specifically, the processor 3002 may operate as a finite-state machine, in response to executable instructions contained within the software modules disclosed herein. These computer-executable instructions may transform the processor 3002 by specifying how the processor 3002 transitions between states, thereby transforming the transistors or other discrete hardware elements constituting the processor 3002.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 3000 in order to store and execute the software components presented herein. It also may be appreciated that the architecture 3000 may include other types of computing devices, including wearable devices, handheld computers, embedded computer systems, smartphones, PDAs, and other types of computing devices known to those skilled in the art. It is also contemplated that the architecture 3000 may not include all of the components shown in FIG. 30, may include other components that are not explicitly shown in FIG. 30, or may utilize an architecture completely different from that shown in FIG. 30.

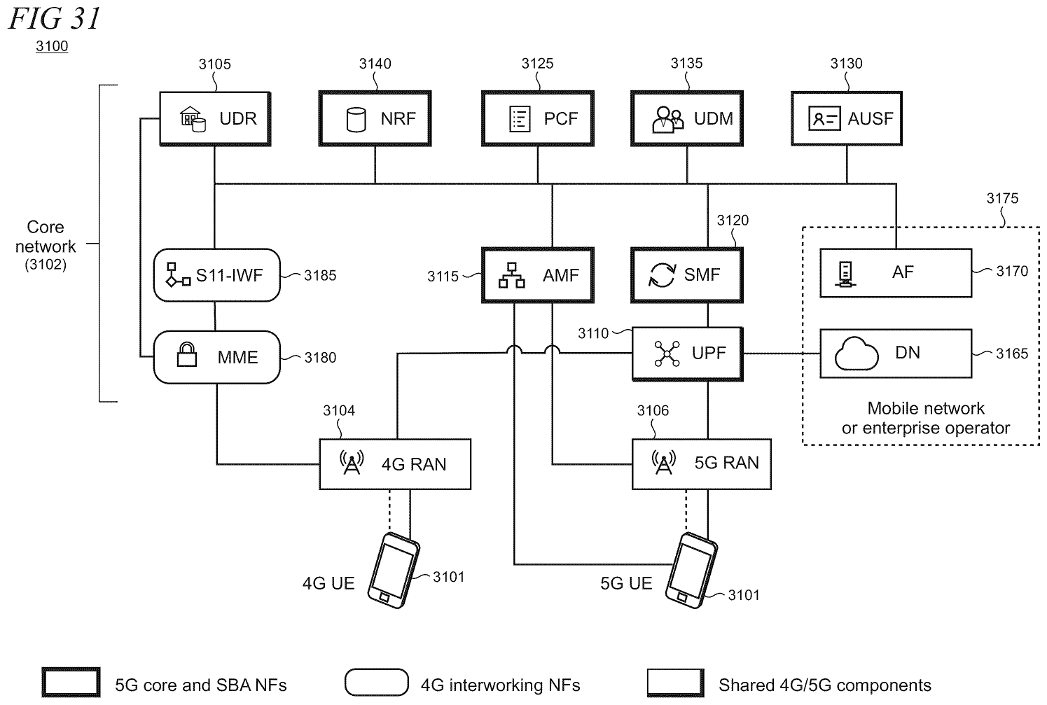

FIG. 31 shows an illustrative mobile network that uses a service-based architecture (SBA) 3100 as defined by 3GPP. An SBA provides a modular framework from which common applications can be deployed using components of varying sources and vendors. Control plane functionality and common data repositories of the network are delivered by way of a set of Network Functions (NFs) that are interconnected with a service-based interface bus, in which each has authorization to access each other's services. Assuming the role of either service consumer or service producer, NFs are self-contained, independent, and reusable. Each NF service exposes its functionality through a Service Based Interface (SBI), which employs a well-defined REST (Representational State Transfer) interface using HTTP/2 (Hypertext Transfer Protocol Version 2).

As shown, the mobile network includes a CN 3102 that is interoperable with 4G (4th generation) and 5G RANs 3104 and 3106 that support wireless communications with UE 3101. The SBA architecture 3100 supports a 5G next generation core (NGC) network that includes 4G evolved packet core (EPC) instances to enable some 4G LTE (Long Term Evolution) use cases when implementing the present principles. With 4G mode, some 5G components such as the UDR (unified data repository) 3105 and UPF (user plane function) 3110 support 4G mode without the need to revert to a legacy 4G stack. Other 4G components include an MME (mobility management entity) 3180 and IWF (interworking function) 3185.

The UPF handles user data, performing operations such as maintaining PDU (Protocol Data Unit) sessions, packet routing and forwarding, packet inspection, policy enforcement for the user plane, QoS handling, traffic usage reporting for billing, and the like. The UPF further provides an interconnection point between the mobile network infrastructure and an external DN 3165. The AF (application function) 3170 provides service or application related information to a VNF service consumer, for example, a mobile network or enterprise operator 3175.

The AMF (access and mobility management function) 3115 receives all connection and session related information from the UE 3101 but is only responsible for handling connection and mobility management tasks such as registration and authentication, identification, and mobility. All messages related to session management are forwarded over an interface to the Session Management Function (SMF) 3120 that establishes and manages sessions. It also selects and controls the UPF 3110 and handles paging. The AF 3170 provides service or application related information to the NF service consumer. For example, the AF performs operations such as retrieving resources and exposing services to end-users. Other 3GPP-defined 5G network functions in the architecture 3100 include SMF (session management function) 3120; PCF (policy control function) 3125; AUSF (authentication server function 3130; UDM (unified data management) 3135; and NRF (network repository function) 3140.

Various exemplary embodiments of the present principles are now presented by way of illustration and not as an exhaustive list of all embodiments. An example includes a method, operable on a computing device in a core network of a wireless communications network, for controlling paging of user equipment (UE), comprising: receiving RAT (radio access technology) information from an NG-RAN (next generation radio access network) having a gNodeB base station that provides connectivity between the UE and a core network, in which the RAT information indicates an NTN (non-terrestrial network) type supported by the gNodeB, the NTN type including non-geostationary satellite orbit (NGSO) and geostationary satellite orbit (GSO); receiving an initial UE message from the NG-RAN responsive to a UE performing an initial registration with the wireless communications network; in response to the initial UE message, requesting UE radio capability information in a downlink NAS (non-access stratum) message to the NG-RAN; receiving UE radio capability information from the NG-RAN indicating whether the UE is NGSO-capable or GSO-capable; comparing the NTN type supported by the gNodeB with the UE radio capability information; and applying a paging policy responsively to the comparing.

In another example, the application of paging policy comprises enabling emergency paging only for the UE. In another example, the application of paging policy comprises setting NG-RAN paging priority. In another example, the setting of NG-RAN paging priority is implemented using a PDU (protocol data unit) session resource setup request to the NG-RAN. In another example, messaging between the NG-RAN and core network is implemented using an access and mobility function (AMF) component of the core network. In another example, the application of paging policy is performed responsively to the UE not marking a cell associated with the gNodeB as barred. In another example, the core network is incorporated in a 5th generation (5G) network using a software-defined networking (SDN) architecture. In another example, the initial UE message and UE radio capability information are arranged in accordance with ETSI (European Telecommunications Standards Institute) TS 123 502 v17 relating to aspects of 3GPP (3rd Generation Partnership Project) Release 17 for 5th generation (5G) mobile networks.

A further example includes one or more hardware-based non-transitory computer-readable memory devices storing computer-executable instructions which, upon execution by one or more processors disposed in a computing device in a core network of a wireless communications network, cause the computing device to: implement an access and mobility function (AMF) component in the core network; responsively to user equipment (UE) entering a non-terrestrial network (NTN) cell supported by a coverage area of a geostationary satellite orbit (GSO) satellite, receive a registration request message at the AMF from a next generation radio access network (NG-RAN); responsively to the registration request, send a registration accept message from the AMF to the NG-RAN, in which the registration accept message comprises a tracking area identity (TAI) list providing a list of TAIs belonging to a non-terrestrial network (NTN) cell; and responsively to the UE entering an NTN cell supported by a coverage area of a non-geostationary satellite orbit (NGSO) satellite, receive a registration request message from the NG-RAN, in which the registration request message includes a TAI.

In another example, the TAI list defines a unique tracking area code (TAC) that is associated with the NTN cell supported by the coverage area of the NGSO satellite. In another example, the TAI list supports a maximum number of 16 TAIs. In another example, the TAI list is a type 4 information element as defined by ETSI (European Telecommunications Standards Institute) TS 123 501 v17 relating to aspects of 3GPP (3rd Generation Partnership Project) Release 17 for 5th generation (5G) mobile networks having a minimum length of 9 octets and a maximum length of 114 octets, wherein bit 5 and bit 8 of the first octet are utilized to identify a number of elements in the list such that the maximum number of TAIs supported is 64. In another example, the TAI list is a type 4 information element as defined by ETSI (European Telecommunications Standards Institute) TS 123 501 v17 relating to aspects of 3GPP (3rd Generation Partnership Project) Release 17 for 5th generation (5G) mobile networks having a minimum length of 9 octets and a maximum length of 114 octets. In another example, the coverage area comprises a beam of the NGSO satellite, wherein the NGSO satellite is a multi-beam satellite. In another example, the computer-executable instructions, when executed by the one or more processors, further cause the computing device to receive UE capability information at the AMF from the NG-RAN indicating that the UE supports NTN access.

A further example includes a computing device operable in a core network of a wireless network, comprising: a processor; a hardware-based non-transitory computer-readable storage device having computer-executable instructions stored thereon which, when executed by the processor, cause the computing device to: receive a handover required message at an access and mobility function (AMF) component of the core network from a source next generation radio access network (NG-RAN) indicating that user equipment (UE) is being handed over to a target NG-RAN, the source and target NG-RANs being respectively associated with different non-terrestrial network (NTN) cells, in which the handover required message comprises a target identifier (ID) for the target NG-RAN including a global NTN node ID and a selected tracking area identity (TAI); and send a handover command from the AMF to the source NG-RAN to trigger the UE to disconnect from the source NG-RAN and connect to the target NG-RAN.

In another example, the source NG-RAN is associated with a geostationary satellite orbit (GSO) satellite and the target NG-RAN is associated with a non-geostationary satellite orbit (NGSO) satellite. In another example, the computer-executable instructions, when executed by the processor, further cause the computing device to receive a registration request from the target NG-RAN responsively to the source NG-RAN and target NG-RAN having different tracking area codes. In another example, the computing device is instantiated in physical network infrastructure used in a 4G (4th generation) or a 5G (5th generation) mobile network. In another example, the target ID is a globally unique identifier.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, operable on a computing device in a core network of a wireless communications network, for controlling paging of user equipment (UE), comprising:
receiving RAT (radio access technology) information from an NG-RAN (next generation radio access network) having a gNodeB base station that provides connectivity between the UE and a core network, in which the RAT information indicates an NTN (non-terrestrial network) type supported by the gNodeB, the NTN type including non-geostationary satellite orbit (NGSO) and geostationary satellite orbit (GSO);
receiving an initial UE message from the NG-RAN responsive to a UE performing an initial registration with the wireless communications network;
in response to the initial UE message, requesting UE radio capability information in a downlink NAS (non-access stratum) message to the NG-RAN;
receiving UE radio capability information from the NG-RAN indicating whether the UE is NGSO-capable or GSO-capable;
comparing the NTN type supported by the gNodeB with the UE radio capability information; and
applying a paging policy responsively to the comparing.

2. The method of claim 1 in which the application of paging policy comprises enabling emergency paging only for the UE.

3. The method of claim 1 in which the application of paging policy comprises setting NG-RAN paging priority.

4. The method of claim 3 in which the setting of NG-RAN paging priority is implemented using a PDU (protocol data unit) session resource setup request to the NG-RAN.

5. The method of claim 1 in which messaging between the NG-RAN and core network is implemented using an access and mobility function (AMF) component of the core network.

6. The method of claim 1 in which the application of paging policy is performed responsively to the UE not marking a cell associated with the gNodeB as barred.

7. The method of claim 1 in which the core network is incorporated in a 5th generation (5G) network using a software-defined networking (SDN) architecture.

8. The method of claim 1 in which the initial UE message and UE radio capability information are arranged in accordance with ETSI (European Telecommunications Standards Institute) TS 123 502 v17 relating to aspects of 3GPP (3rd Generation Partnership Project) Release 17 for 5th generation (5G) mobile networks.

9. One or more hardware-based non-transitory computer-readable memory devices storing computer-executable instructions which, upon execution by one or more processors disposed in a computing device in a core network of a wireless communications network, cause the computing device to:
implement an access and mobility function (AMF) component in the core network;
responsively to user equipment (UE) entering a non-terrestrial network (NTN) cell supported by a coverage area of a geostationary satellite orbit (GSO) satellite, receive a registration request message at the AMF from a next generation radio access network (NG-RAN);
responsively to the registration request, send a registration accept message from the AMF to the NG-RAN, in which the registration accept message comprises a tracking area identity (TAI) list providing a list of TAIs belonging to a non-terrestrial network (NTN) cell; and
responsively to the UE entering an NTN cell supported by a coverage area of a non-geostationary satellite orbit (NGSO) satellite, receive a registration request message from the NG-RAN, in which the registration request message includes a TAI.

10. The one or more hardware-based non-transitory computer-readable memory devices of claim 9 in which the TAI list defines a unique tracking area code (TAC) that is associated with the NTN cell supported by the coverage area of the NGSO satellite.

11. The one or more hardware-based non-transitory computer-readable memory devices of claim 10 in which the TAI list supports a maximum number of 16 TAIs.

12. The one or more hardware-based non-transitory computer-readable memory devices of claim 10 in which the TAI list is a type 4 information element as defined by ETSI (European Telecommunications Standards Institute) TS 123 501 v17 relating to aspects of 3GPP (3rd Generation Partnership Project) Release 17 for 5th generation (5G) mobile networks having a minimum length of 9 octets and a maximum length of 114 octets, wherein bit 5 and bit 8 of the first octet are utilized to identify a number of elements in the list such that the maximum number of TAIs supported is 64.

13. The one or more hardware-based non-transitory computer-readable memory devices of claim 10 in which the TAI list is a type 4 information element as defined by ETSI (European Telecommunications Standards Institute) TS 123 501 v17 relating to aspects of 3GPP (3rd Generation Partnership Project) Release 17 for 5th generation (5G) mobile networks having a minimum length of 9 octets and a maximum length of 114 octets.

14. The one or more hardware-based non-transitory computer-readable memory devices of claim 13 in which the coverage area comprises a beam of the NGSO satellite, wherein the NGSO satellite is a multi-beam satellite.

15. The one or more hardware-based non-transitory computer-readable memory devices of claim 9 in which the computer-executable instructions, when executed by the one or more processors, further cause the computing device to receive UE capability information at the AMF from the NG-RAN indicating that the UE supports NTN access.

16. A computing device operable in a core network of a wireless network, comprising:
a processor;
a hardware-based non-transitory computer-readable storage device having computer-executable instructions stored thereon which, when executed by the processor, cause the computing device to:
receive a handover required message at an access and mobility function (AMF) component of the core network from a source next generation radio access network (NG-RAN) indicating that user equipment (UE) is being handed over to a target NG-RAN, the source and target NG-RANs being respectively associated with different non-terrestrial network (NTN) cells, in which the handover required message comprises a target identifier (ID) for the target NG-RAN including a global NTN node ID and a selected tracking area identity (TAI); and
send a handover command from the AMF to the source NG-RAN to trigger the UE to disconnect from the source NG-RAN and connect to the target NG-RAN.

17. The computing device of claim 16 in which the source NG-RAN is associated with a geostationary satellite orbit (GSO) satellite and the target NG-RAN is associated with a non-geostationary satellite orbit (NGSO) satellite.

18. The computing device of claim 16 in which the computer-executable instructions, when executed by the processor, further cause the computing device to receive a registration request from the target NG-RAN responsively to the source NG-RAN and target NG-RAN having different tracking area codes.

19. The computing device of claim 16 as instantiated in physical network infrastructure used in a 4G (4th generation) or a 5G (5th generation) mobile network.

20. The computing device of claim 16 in which the target ID is a globally unique identifier.
